(19) United States
(12) Patent Application Publication
(10) Pub. No.: US 2010/0042517 A1
(43) Pub. Date: Feb. 18, 2010

(54) UNIVERSAL LOYALTY SYSTEMS AND METHODS

(75) Inventors: Scott Paintin, Littleton, CO (US); Melanie Roberts, Castle Rock, CO (US); Gail Galuppo, Lone Tree, CO (US)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: The Westem Union Company, Englewood, CO (US)

(21) Appl. No.: 12/190,348

(22) Filed: Aug. 12, 2008

(51) Int. Cl. G06Q 10/00; G06Q 30/00

(52) U.S. Cl. 705/30

(57) ABSTRACT

The invention provides various systems and methods for providing universal access to loyalty programs and/or financial accounts. The method includes initializing a universal loyalty program account and financial account device. The method further includes associating loyalty program accounts and/or financial accounts with the universal loyalty program and financial instrument device. The method then accesses at least one of the loyalty program accounts and/or the financial accounts at a customer facing device using the universal loyalty program account and financial account device.

### FIELD OF THE INVENTION

The present invention relates, in general, to loyalty programs, and more particularly, to a universal loyalty program associated with multiple vendors and/or financial institutions.

### BACKGROUND OF THE INVENTION

Currently, an average consumer may have a large number of loyalty program cards, key fobs, IDs, etc. associated with a variety of vendors/retailers. Such a large number of items can be cumbersome to maintain, for example, on a keychain, in a handbag, in a wallet, etc. Furthermore, many consumers simply choose not to utilize loyalty programs due to the burden of keeping track of the cards and/or key fobs associated with the different programs. For example, it is not uncommon for a single consumer to have separate cards or key fobs for use in purchasing groceries, gas, money transfer services, shoes, greeting cards, sporting goods, etc. Thus, vendors lose loyalty business from consumers that would otherwise be willing to participate in such programs.

Furthermore, many consumers carry a wide variety of credit cards, debit cards, vendor specific credit cards, stored value cards, and the like, which can also be cumbersome and unwieldy. Thus, between loyalty program and financial instruments consumers are overwhelmed with cards, IDs, key fobs, and other such instruments. Accordingly, improvements in the art are needed.

### BRIEF SUMMARY OF THE INVENTION

The present invention provides a method of providing universal access to loyalty program accounts and/or financial accounts. The method includes initializing a universal loyalty program account and/or financial account device. The method further includes associating loyalty program accounts and/or financial accounts with the universal loyalty program and/or financial instrument device. The method then accesses at least one of the loyalty program accounts or the financial accounts at a customer facing device using the universal loyalty program account and/or financial account device. Thus, the uniform loyalty program account and/or financial account device may be used to access a plurality of loyalty accounts, a plurality of financial accounts, and/or at least one loyalty account associated with at least one financial account.

A further embodiment provides a universal loyalty program account and/or financial account device. The device includes a storage mechanism configured to store account information for loyalty program accounts and/or financial accounts associated with the universal loyalty program account and/or financial account device. The device can further includes a display screen coupled with the storage mechanism. The display screen can be configured to display account information for one or more of the loyalty program accounts or the financial accounts. The device can also includes a button mechanism coupled with the storage mechanism and/or the display screen. The button mechanism can be configured to manipulate the account information displayed on the display screen.

An alternative embodiment provides a system for providing universal access to loyalty program accounts. The system includes a processing center which is configured to initialize a universal loyalty program account device and/or associate loyalty program accounts with the universal loyalty program. The system further includes a customer facing device coupled with the processing center. The customer facing device is configured to access at least one of the loyalty program accounts using the universal loyalty program account device.

A further embodiment of the present invention provides a machine-readable medium for providing universal access to loyalty program accounts and/or financial accounts. The machine-readable medium includes providing universal access to loyalty programs and/or financial accounts. The machine-readable medium includes instructions for initializing a universal loyalty program account and/or financial account device. The machine-readable medium further includes instructions for associating loyalty program accounts and/or financial accounts with the universal loyalty program and/or financial instrument device. The machine-readable medium includes instructions for accessing at least one of the loyalty program accounts or the financial accounts at a customer facing device using the universal loyalty program account and/or financial account device.

### BRIEF DESCRIPTION OF THE DRAWINGS

A further understanding of the nature and advantages of the present invention may be realized by reference to the remaining portions of the specification and the drawings wherein like reference numerals are used throughout the several drawings to refer to similar components. In some instances, a sublabel is associated with a reference numeral to denote one of multiple similar components. When reference is made to a reference numeral without specification to an existing sublabel, it is intended to refer to all such multiple similar components.

FIG. 1 is a flow diagram illustrating a method of establishing and providing universal access to loyalty programs and/or financial accounts, according to one embodiment of the present invention.

FIG. 2 is a flow diagram illustrating a method of accessing a universal loyalty program and/or universal financial account, according to one embodiment of the present invention.

FIG. 3 is a block diagram illustrating a method of universally using rewards from loyalty programs and/or financial accounts, according to one embodiment of the present invention.

FIG. 4 is a block diagram illustrating a system for providing universal access to loyalty programs and/or financial accounts, according to one embodiment of the present invention.

FIG. 5 is a block diagram illustrating a device used for providing universal access to loyalty programs and/or financial accounts, according to one embodiment of the present invention.

FIGS. 6A and 6B are block diagrams illustrating a presentation instrument for providing universal access to loyalty programs and/or financial accounts, according to one embodiment of the present invention.

FIG. 7 is a generalized schematic diagram illustrating a computer system, in accordance with various embodiments of the invention.

FIG. 8 is a block diagram illustrating a networked system of computers, which can be used in accordance with various embodiments of the invention.

### DETAILED DESCRIPTION OF THE INVENTION

The invention provides various systems and methods for providing universal access to loyalty programs and/or financial accounts. Embodiments of the present invention relate to providing a consolidated and universal method and/or device for loyalty programs and/or financial accounts. For example, aspects of the present invention allow a consumer to maintain a single device, presentation instrument, etc. which provides the customer access to all of their loyalty programs and/or financial accounts. Accordingly, the customer only needs to carry a single device or presentation instrument as opposed to one for each program and/or account.

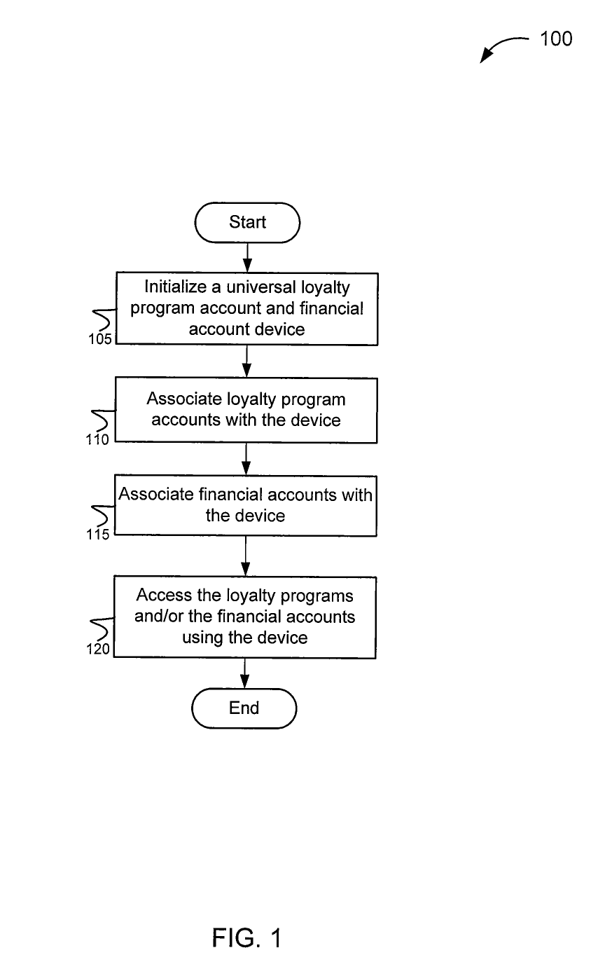

Turning now to FIG. 1, which illustrates a method 100 of providing universal access to loyalty programs and/or financial accounts, according to embodiments of the present invention. At process block 105, a device for utilization with universal loyalty and/or financial accounts may be initialized. In one embodiment, the device may be a presentation instrument, a mobile device (i.e., a cellular device, a personal digital assistant (PDA), a portable computing device, etc.), a key fob, etc. The device may have a storage medium for storing information associated with the loyalty programs and/or the financial accounts. Furthermore, the device may include an interfacing mechanism (e.g., a universal serial bus (USB) connection, a Bluetooth connection, a wireless connection, Firewire connection, etc.), a display mechanism, etc.

In a further embodiment, a universal loyalty and/or financial account may be generated during the initialization process. The universal loyalty and/or financial account may be configured to include multiple individual loyalty program accounts and/or financial accounts in a single universal account. As such, information associated with each of the individual accounts (e.g., account number, customer name, account identifier, associated financial institution, associated merchant, reward program details, etc.) may be maintained within the universal loyalty and/or financial account. Accordingly, a customer is able to utilize the universal loyalty and/or financial account in order to access any of the associated loyalty/financial accounts.

At process block 110, individual loyalty program cards, devices or accounts may be associated with the device. In one embodiment, the loyalty programs may be associated with merchants of goods or services, for example, a grocery store, a department store, a shoe store, a utility company, a retail store, a video rental store, a movie theater, an airline, a hotel chain, a car rental operator, a clothing store, a financial institution, a card association, a casino, etc. Each loyalty program may have an account number or other unique identifier in order to identify the specific loyalty account. The loyalty accounts may have an associated rewards program which may, for example, accumulate points which can be redeemed by the consumer. In one embodiment, the points may be used for stored credit, rebates, coupons, discounts, cash, checks, money orders, airline miles, telephone time, gift cards, gift certificates, sweepstakes entries, etc. These rewards may also be earned directly (i.e., independent of points). Furthermore, the reward program may have rules and regulations which dictate how a consumer may accumulate and/or use the rewards points.

For example, the loyalty rewards program may be a frequent flyer loyalty program associated with an airline carrier. The airline carrier may award the consumer one point/mile for each mile/dollar of airline travel purchased. The consumer may then be able to use the points/miles to purchase subsequent airline tickets. The program may have restrictions, such as the points/miles can only be used to purchase tickets on off-peak travel dates, only on weekdays, only after 6 p.m., etc. Alternatively, the rewards program may be for a grocery store which, when used in connection with purchasing certain grocery items provides the customer with a discount. Examples of loyalty rewards programs are described in commonly-owned U.S. patent application Ser. No. 10/687,575, entitled MONEY TRANSFER CONVENIENCE CARD, SYSTEMS AND METHODS, filed on Nov. 15, 2003, and U.S. patent application Ser. No. 11/007,649, entitled LOYALTY PROGRAM ENROLLMENT SYSTEMS AND METHODS, filed on Dec. 6, 2004, the complete disclosures of which are incorporated herein by reference for any and all purposes. Loyalty rewards programs may also include membership or participation in organizations or associations from which rewards may or may not be earned or received. For example, loyalty rewards programs may include membership in professional organizations (e.g., bar associations), fraternal societies, student organizations or affiliations, alumni associations, government programs or organizations (e.g., libraries), government assistance programs, etc. or may be reflective of citizenship or residency (e.g., passports, drivers' licenses, etc.). It should be appreciated that any other loyalty rewards program known to one of ordinary skill in the art may be used.

At process block 115, financial cards, devices, and/or accounts may be associated with the device. For example, a credit card, a debit card, a smart card, a prepaid card, a gift card, and/or a stored value card, etc. or any account(s) tied to such card(s) may be associated with the device. Other types of accounts that may be associated with the device including, for example, checking accounts, savings accounts, money market accounts, investment accounts, retirement accounts, government benefit or assistance accounts, education accounts, trust fund accounts, etc. As such, instead of having an individual card for each financial account type, the customer is able maintain a single device which can be used to access each of their financial accounts. Similar to the loyalty programs the financial programs may or may not have associated rewards programs. For example, a credit card may allow a consumer to accumulate points for every dollar(s) spent using the credit card account. Alternatively, the consumer may be given a certain percentage cash-back on purchases made. Furthermore, the rewards may be specific to the type of item purchased (e.g., gas, dining, groceries, travel, etc.). However, it should be appreciated that any other rewards program known to one of ordinary skill in the art may be used.

At process block 120, the loyalty and/or financial accounts may be accessed using the universal device. In one embodiment, a consumer may be shopping at, for example, a grocery store, and the consumer sees that ice cream may be purchased for $1.00 off with the use of their loyalty card. The consumer decides to purchase the ice cream and brings the ice cream to the check-out line for purchase. When prompted to present the consumer's loyalty card, the consumer simply presents the universal device which is configured to access the loyalty account information (e.g., specific to the grocery store) in order to discount the ice cream by $1.00. Loyalty account information may be specific to any store, to any chain of stores, to any multi-merchant group of stores and/or chains (e.g., a particular mall), or to any geography (e.g., a particular city, metropolitan area, state, country, etc.).

Furthermore, when the consumer is prompted to present payment for the ice cream (along with any other items which the consumer may have purchased), the consumer may again use the universal device to pay for the items by accessing one of the consumer's financial accounts associated with the universal device. Accordingly, the consumer is able to participate in the loyalty program as well as present payment for the items purchased, using only the universal device.

In addition, any points and/or rewards associated with the loyalty program and/or the financial account used for the transaction can be calculated and stored for the consumer. As will be described in more detail below, the consumer may then access their accumulated points/rewards and manage them accordingly.

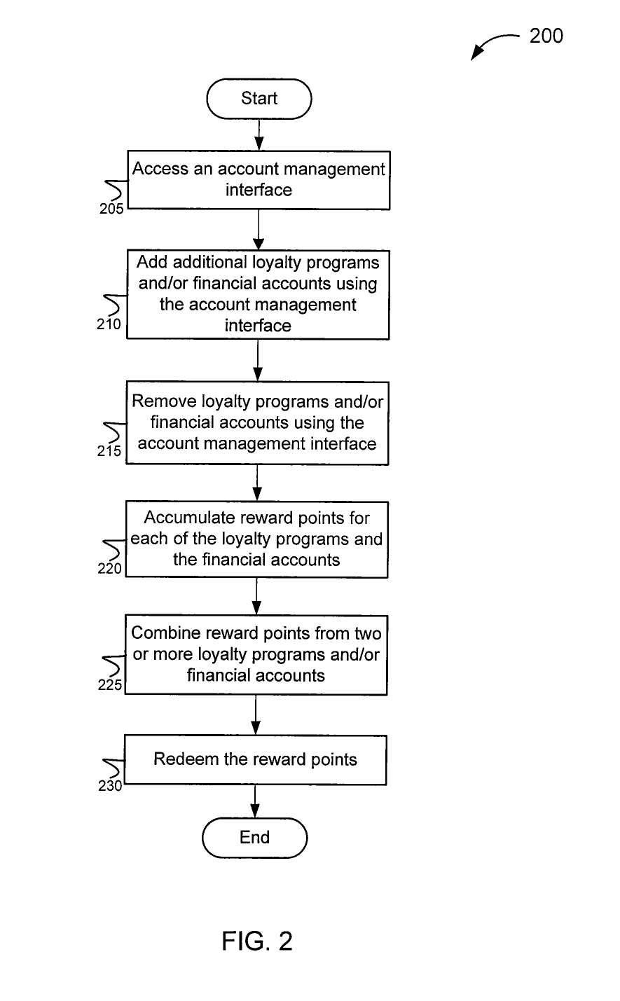

Referring now to FIG. 2, which illustrates a method 200 of accessing a universal loyalty program and/or universal financial account, according to embodiments of the present invention. At process block 205, an account management interface may be accessed. In one embodiment, the interface may be accessed via a web-based interface, a mobile computing platform, a kiosk, an automated teller machine (“ATM”), an interactive voice response (“IVR”), voice recognition unit (“VRU”), etc. The interface may require any one or more authentication factors to access the account management interface. Authentication factors can include a username (e.g., a unique ID, e-mail address, or other personal identifier, etc.), password (e.g., control number), personal identification number (“PIN”), biometric feature (e.g., fingerprint, voice print, palm scan, retinal scan, unique signature or other unique feature, etc.), or other similar login mechanism for authentication. In some embodiments, authentication may occur at a single level or layer, while in other embodiments, authentication may occur through multiple layers. Also, authentication may completely occur through a single channel or may occur, at least in part, through one or more other channels (e.g., when a consumer accesses the interface at POS, one or more pieces of information may be required to be received from the consumer through a pre-registered wireless device or in response to a message sent to such wireless device, etc.). For added security, the consumer also may be provided with the ability to set one or more account parameters. The account parameters can be any restriction or limitation that can be placed on an account, including without limitation, setting a dollar threshold for purchases, restricting certain types of purchases of goods and/or services (e.g., the device may not be used for gambling or to purchase alcohol or cigarettes, etc.), limiting where the device may be used (e.g., by type of merchant, by geography, by channel (such as over the Internet or telephone), and/or limiting the velocity of purchases (e.g., no more that four purchases in any two-hour period). If any set parameter is met, further authentication may be required (either by the processing center or other program operator or in accordance with instructions provided by the consumer. Further authentication may involve any one or more of the methods described herein or may require further action (e.g., speaking with a live operator, answering questions derived from credit bureaus and/or databases of public information, etc.). In the event that further authentication is successful, the parameter may be exceeded, suspended or removed. The interface may provide the consumer with a listing/overview of each of the consumer's loyalty/financial accounts. For example, the interface may provide a loyalty programs tab and/or a financial accounts tab, where each tab, when clicked on, lists each of the loyalty or financial accounts. The list may be, for example, sorted alphabetically, by rating, importance to the consumer, etc.

Furthermore, each account listing may be a link which when clicked provides additional information regarding the account. For example, the accumulated rewards points, the account number, the expiration data, balance, account activity, recent transactions, stored merchant details, pending transactions, recurring transaction data, etc. may be displayed. The reward program rule and restrictions may also be displayed. Accordingly, any information related to the account may be displayed.

At process block 210, the interface may provide the consumer with the ability to add (or remove, process block 215) loyalty/financial accounts from the universal device. When adding a new account the interface may prompt the consumer to enter identification information for the account (e.g., the account number, the routing number, the associated card association, retailer and/or financial institution, expiration date, card verification value code (CVC), CVC2, etc.). The consumer may enter information by any appropriate means, including for example, manually via a keyboard, numeric keypad or touch screen, by swiping a card with a magnetic stripe, by reading a chip (e.g., RFID, near-field communication, Blue Tooth, 802.11, etc.), by connecting device to a computer (e.g., by a cable or docking station), etc. Once, the account has been added, the account then appears in the list with the other accounts and may be accessed to view reward points, see balances, check for special offers, etc. Additionally, any of the accounts may be removed from the universal device (process block 215).

At process block 220, as the various accounts are used by the consumer, the accounts can accumulate rewards and other points according to the account's prescribed rewards program, if any. Such accumulated rewards can be tracked and displayed at or through the interface. Thus, each time the consumer logs on or accesses the interface, an updated accounting of rewards for each account will be displayed.

In one embodiment, the interface may further provide the consumer with the option of combining rewards from one or more accounts (process block 225), as well as transferring rewards from one account to another. A rewards summary tab may be presented which may provide an aggregated summary for all of the accounts. Furthermore, the interface may present the consumer with conversion calculations, conversion restrictions, etc. For example, assuming that the consumer has one hundred frequent purchaser points from a shoe store, five hundred frequent flyer miles from an airline, and three hundred cash-back reward points from a credit card, the consumer may be able to combine/transfer these rewards in a variety of ways. In one embodiment, if the consumer desires to convert all of the rewards into frequent flyer miles, the one hundred frequent purchaser points may convert to fifty frequent flyer miles, and the three hundred cash-back rewards points may convert to one hundred frequent flyer miles. Accordingly, after combining the rewards from the shoe store and the credit card, the consumer would have a total of six hundred and fifty frequent flyer miles. Nonetheless, other combinations may be made as well as other conversion rates/penalties may be calculated. Furthermore, the provider of the universal device and/or the merchants/financial institutions may charge a fee for transferring and/or combining the rewards. The fee may be transaction based, percentage based, net fee, etc. The processing center or the provider of the universal device may use various exchange rates for the transfer and/or conversion of rewards. The exchange rates may vary over time and may vary from one merchant/financial institution to another. In addition, the processing center or the provider of the universal service device may offer consumers the same exchange rate it receives from a merchant/financial institution or it may be able to obtain rewards from a merchant/financial institution at one exchange rate and offer those rewards to consumers at a different exchange rate.

Alternatively, the consumer may be provided the option of converting account specific rewards/points into universal rewards/points. Once the account specific rewards/points have been converted into universal rewards/points, the consumer is able to use the universal rewards/points to redeem rewards from any account specific rewards program; thus, affording the consumer with an added level of flexibility.

In a further embodiment, special offers, coupons, rebates, special combined offers, sweepstakes, etc. may be presented to the consumer through the interface. Alternatively, these offers and/or promotions may be presented to the consumer in a message format, such as, a short message service (SMS) message, an email, a voicemail, regular post, an instant message, etc. A particular message format may direct the consumer how to retrieve some or all of the offer and/or promotion through the message format (e.g., an email containing a link to a landing page) and/or may contain information about how the consumer can retrieve some or all of the offer and/or promotion through another format (e.g., a direct mail piece may instruct a consumer to visit a particular website or call a particular telephone number to obtain the offer/promotion or further details about the offer/promotion). A combined offer may consist of, for example, if the consumer purchases a plane ticket and rents a rental car at the same time, the reward points for both the airline and the rental car are doubled. Alternatively, if the consumer used both their grocery rewards account and a certain credit card to purchase an item, the credit card rewards are tripled. Hence, a wide variety of special offers may be presented to the consumer based at least in part on the loyalty/financial accounts associated with the universal device.

In another embodiment, one consumer may be able to transfer rewards value to another consumer. For example, a first consumer could transfer 500 minutes of telephone time to a second consumer, who receives 500 minutes of telephone time. Such a transfer may include an accompanying fee, charge, penalty, etc. in order to complete the transfer. The transferring consumer may also be able to transfer one type of rewards value to the receiving consumer in which the receiving consumer receives rewards value of a different type. For example, the first consumer may choose to transfer 500 minutes of the consumer's telephone time so that the second consumer could receive 75 reward points in either the same or another loyalty program. The transferring consumer and the receiving consumer may be the same or different parties. The type of reward received may be selected by the transferring consumer or the receiving consumer or may be required by the processing center, the provider of the universal device, merchant(s), and/or financial institution(s). It should be noted that agreements may be made with the retailers, distributors, financial institutions, etc. which are associated with the various rewards programs in order to allow consumers to combine and/or transfer rewards value.

At process block 230, the consumer may then redeem the rewards value. In one embodiment, the consumer may be able to access a rewards redemption section of the interface to choose from various rewards redemption offers. Alternatively, the consumer may be linked to the homepages (or rewards pages) of retailers, financial institutions, airline carriers, etc. in order to redeem the rewards value.

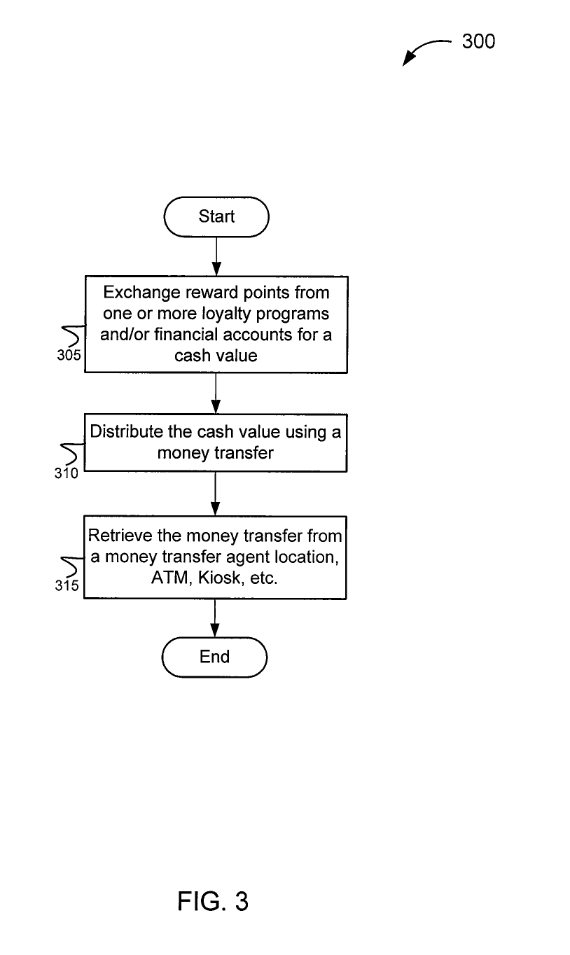

Referring next to FIG. 3, which illustrates a method 300 of universally using rewards from loyalty programs and/or financial accounts, according to embodiments of the present invention. In a further embodiment, a consumer may be able to redeem rewards value by exchanging the rewards value for cash value (process block 305). The cash value may then be distributed to the consumer using a money transfer (process block 310), for example, through a licensed money transmitter such a Western Union Financial Services, Inc., or through an agent affiliated with a money transmitter. The money transfer provider may charge a transaction fee which may be in a net fee structure. As such, the fee would be subtracted from in the amount of the money transfer. For example, if the rewards value is sufficient enough to provide the consumer with one hundred and ten dollars, then the consumer would simply receive a one hundred dollar money transfer with ten dollars removed for fees. Nonetheless, other fee structures may be used, for example, the consumer may be charged a fee upon redemption of the reward for the money transfer. Payout of cash value may be accomplished through one of more other financial institutions. Cash value can include cash and cash-equivalents such as, for example, money orders, checks, travelers checks, gift cards, gift certificates, prepaid cards, debit cards, stored value cards, smart cards, sending money to an account associated with the consumer or another party (e.g., family member), providing store credit, etc.

At process block 315, the consumer or other designated recipient may retrieve the money transfer from, for example, a money transfer agent location, an automated teller machine, (ATM), a kiosk, via the account management interface, etc. Alternatively, the cash value may be mailed or sent via courier.

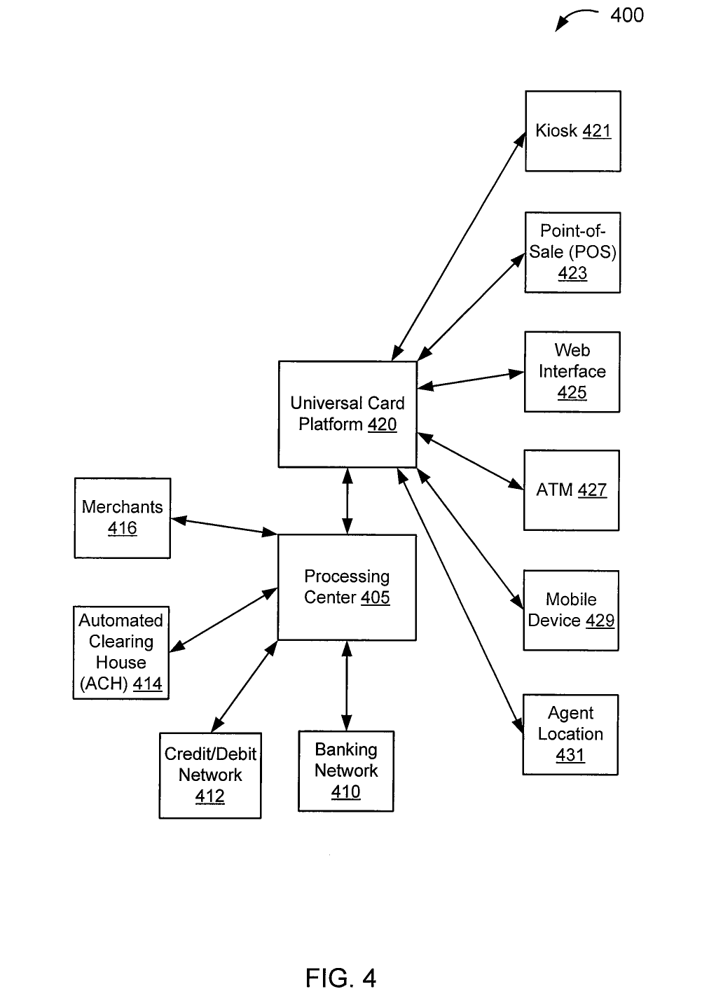

Turning now to FIG. 4, which illustrates a system 400 for providing universal access to loyalty programs and/or financial accounts, according to embodiments of the present invention. In one embodiment, system 400 may include a processing center 405. Processing center 405 may be used to manage the loyalty programs and/or financial accounts associated with the various retailers, vendors, financial institutions, etc. Processing center 405 may be configured to maintain the account management interface, perform the conversion calculations, store account data and consumer personal and/or identification data, etc.

Processing center 405 may be connected with a banking network 410, a credit/debit network 412, an automated clearinghouse (ACH) 414, and/or merchants 416. In one embodiment, processing center 405 may be configured to interface with each of banking network 410, credit/debit network 412, ACH 414, and/or merchants 416. For example, processing center 405 may receive rewards information related to merchants' 416 loyalty programs. The rewards information may be consumer specific (i.e., account information, rewards balance, etc.) or may be general rewards/loyalty offers, coupons, rebates, etc. In one embodiment, merchants 416 may be a grocery store, a shoe store, a video rental store, an airline, a hotel, a rental car chain, a department store, a retail store, etc.

Furthermore, processing center 405 may transmit update information to merchants 416 regarding consumer activity in relation to merchants' 416 loyalty and/or rewards programs. Similarly, banking network 410 and/or credit/debit network 412 may have financial institutions which also have rewards programs and, as such, processing center 405 may be configured to transmit rewards usage information about consumers to banking network 410 and/or credit/debit network 412, as well as receive rewards information. In addition, processing center 405 may receive balance information, interest rate, credit limit, etc. from credit/debit network 412 and/or banking network 410. Processing center 405 may also transmit financial transaction account information to banking network 410 and/or credit/debit network 412.

In one embodiment, system 400 may include a universal card platform 420 connected with processing center 405. Processing center 405 may store, in whole or in part, loyalty program information and/or financial account information. Processing center 405 may be connected with universal card platform 420 via an Internet or other such network connection (e.g., telephone line (e.g., T1 line), virtual private network, Ethernet, wireless connection, etc.). Universal card platform 420 may be connected with a kiosk 421, a point-of-sale (POS) device 423, a web interface 425, an ATM 427, a mobile device 429, and/or an agent location 431. Universal card platform 420 may store, in whole or in part, loyalty program information and/or financial account information. In one embodiment, a consumer may utilize their universal device at any of the locations described above either as a payment mechanism and/or in conjunction with a loyalty program. The universal device may permit certain information relating to the consumer and/or the transaction to be automatically populated at the kiosk 421, POS device 423, web interface 425, ATM 427, mobile device 429, and/or agent location 431 to make a transaction more convenient (e.g., populating a money transfer sender's name, address and/or telephone number or displaying a list of money transfer recipients to whom the sender has previously sent money). For example, a consumer may be at a shoe store and use POS 423 to swipe their universal device to activate their loyalty program, and then use the same universal device to pay for the purchased items. The universal device can be read by any other suitable means, such as, for example, RFID, near-field communication, 802.11, Bluetooth, etc. In one embodiment, POS 423 may be configured as an in-lane device.

In an alternative embodiment, mobile device 429 may be used as the universal device and may be configured to store, in whole or in part, loyalty program information and/or financial account information. In a further embodiment, a consumer is able to access, for example, kiosk 421, POS 423, ATM 427, or agent location 431 to manage their universal loyalty program and/or financial account. The consumer may be presented with a screen which provides management options such as, checking reward point totals, adding and removing accounts, transferring reward value, initiating a cash-value money transfer, transferring rewards value to another consumer, etc.

In a further embodiment, universal card platform 420 may transmit management/usage information which the universal card platform 420 receives to processing center 405, and processing center 405 may then transmit the information to banking network 410, credit/debit network 412, and/or merchants 416. Accordingly, financial transaction and/or reward information is received by banking network 410, credit/debit network 412, and/or merchants 416.

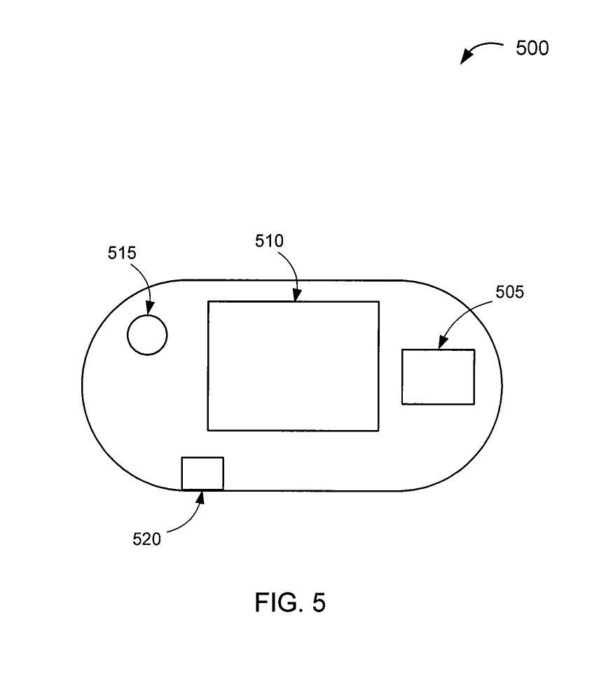

Turning next to FIG. 5, which illustrates a device 500 used for providing universal access to loyalty programs and/or financial accounts, according to embodiments of the present invention. In one embodiment, device 500 is the universal loyalty and/or financial account device described above. Device 500 may be configured as a key fob, or similar type of device. Device 500 may include a memory 505. In one embodiment, memory 505 may be a flash memory, a multimedia memory, a secure digital (SD) memory, miniSD, microSD, etc. Memory 505 may be configured to store information for loyalty program accounts and/or financial accounts.

In a further embodiment, device 500 may include a display 510. In one embodiment, display 510 may be a liquid crystal display (LCD), a light-emitting diode (LED), a touch screen, etc. Display 510 may be configured to display loyalty program rewards information. For example, a consumer may be able to select a rewards program and/or check the rewards value balance. Alternatively, display 510 may provide the consumer with updates on sales, rebates, coupons, and other special offers for the loyalty programs and/or financial accounts associated with device 500. For example, a consumer may be shopping at a video rental store for which the consumer is a loyalty program member, and the device may display a rent one movie get one movie free coupon. Alternatively, device 500 may vibrate or emit a sound through a speaker (not shown) indicating a new message has arrived. The offer may be triggered by the consumer using the universal device to make the purchase and/or obtain loyalty rewards or may be triggered by any other factor(s), such as for example, the consumer's transaction history at this or any other merchant (including for example, frequency, recency, amount spent, types of products or service purchased, etc.), the consumer's current geographic location (which may be determined by radio frequency identification, global positioning system, wireless triangulation and the like), whether the consumer is a first-time purchaser from the merchant, etc.

In yet another embodiment, device 500 and/or display 510 may be configured to display a barcode associated with a loyalty program. Accordingly, the displayed barcode may be swiped or otherwise read at a POS, or similar customer facing device, to verify that the customer is a member of the loyalty program. Furthermore, device 500 may include an interface 515 which, when pressed, may cycle through the loyalty program barcodes associated with device 500. Hence, the consumer may simply cycle through loyalty programs until the program barcode needed appears and then the consumer can scan the barcode at the POS. Alternatively, if display 510 is a touch screen, then the consumer can select the desired loyalty program and, once selected, the barcode for the selected program appears. Device 500 may contain information about a consumer (e.g., in a magnetic stripe or in memory) that may be obtained through the interface when the device is swiped or otherwise read. The information may include any relevant data, including for example, the consumer's universal loyalty account number, universal financial account number, universal loyalty and financial account number, separate loyalty program numbers, separate financial account numbers and/or other financial account information, the consumer's name, address, telephone number, etc. Some or all of the information may be contained in or on the device, while some or all of the information may be stored at and accessible from the processing center, universal card platform, and/or any other system used to provide universal access. Appropriate security measures may be employed to restrict access to the device and the information associated with it, including for example, requiring the consumer to supply one or more user name, password, PIN, biometric feature, etc. at one or more layers, either in-band or out-of-band.

Alternatively, interface 515 may be a trackball, arrow button, or other mechanism for interacting with device 500. Furthermore, interface 515 may be configured to move a cursor displayed on display 510. In a further embodiment, device 500 may include a communications interface 520. Communications interface 520 may be, for example, a universal serial bus (USB) connection, near-field communication, a Bluetooth connection, a Wi-Fi connection, a wireless connection, a cellular connection, a firewire connection, etc. Furthermore, communications interface 520 may be configured to send and receive information to and from device 500. For example, a consumer may connect device 500 with a personal computer and update any account information stored on memory 505 regarding the associated loyalty programs and/or financial accounts. Communications interface 520 may also be used to synchronize account information, to receive reward program updates, to receive special offer messages, rebates, rebate offers, sweepstakes entries, etc.

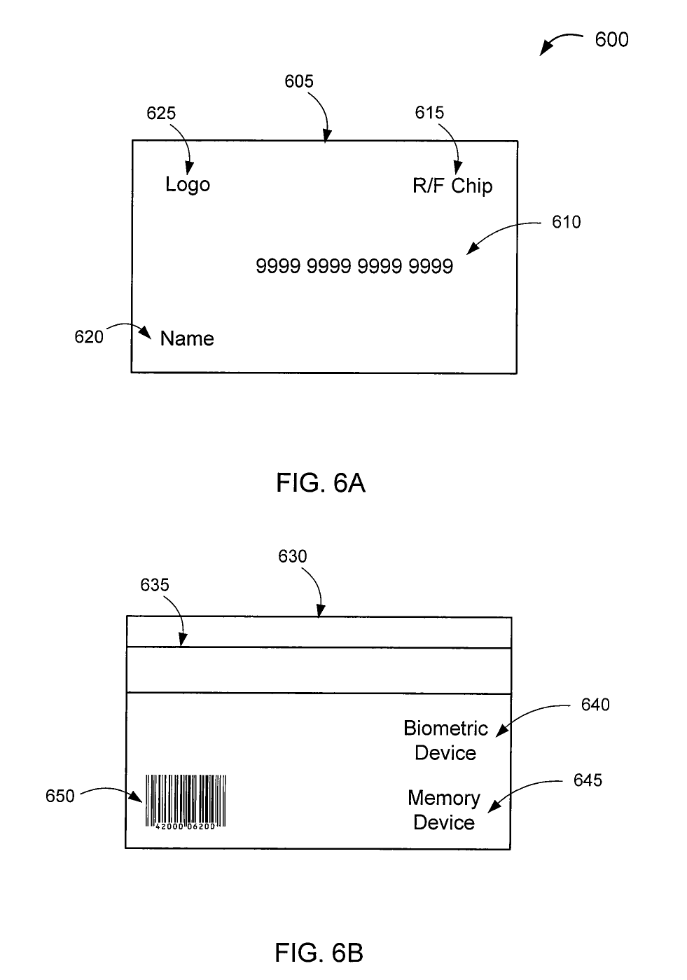

Referring now to FIG. 6A, which illustrates a presentation instrument 600 for providing universal access to loyalty programs and/or financial accounts, according to embodiments of the present invention. Presentation instrument 600 may include a front side 605 which may include an account number 610, a name 620, and/or a logo 625. In one embodiment, account number 610 may be a unique identifier for a consumer's universal loyalty and/or financial account. Name 620 may be the consumer's name, and logo 625 may be a logo for the entity which is servicing the universal account.

In a further embodiment, presentation instrument 600 may include a radio frequency (R/F) chip 615. R/F chip 615 may be configured to transmit information to, for example, Kiosk 421 (FIG. 4), POS 423 (FIG. 4), or ATM 427 (FIG. 4). Furthermore, R/F chip 615 may transmit loyalty program information and/or financial account information associated with the universal loyalty program and/or financial account. Transmissions, data packet(s) and/or the pipes used for transmission may be secured by appropriate means (e.g., encryption).

Referring next to FIG. 6B, which further illustrates a presentation instrument 600 for providing universal access to loyalty programs and/or financial accounts, according to embodiments of the present invention. Presentation instrument 600 may include a back side 630. In one embodiment, back side 630 may include a magnetic stripe 635. Magnetic stripe 635 may include account information which can be swiped at a POS 423 (FIG. 4), kiosk 421 (FIG. 4), ATM 427 (FIG. 4), etc. Furthermore, presentation instrument 600 may include a biometric device 640, a memory device 645, and/or a barcode 650.

In one embodiment, biometric device 640 (e.g., a retinal scanner, a thumbprint scanner, etc.) may be configured to provide security for presentation instrument 600. Memory device 645 may store account and/or other information related to the universal loyalty and/or financial account. Barcode 650, similar to magnetic stripe 635 may be used to transmit account information to a receiving device.

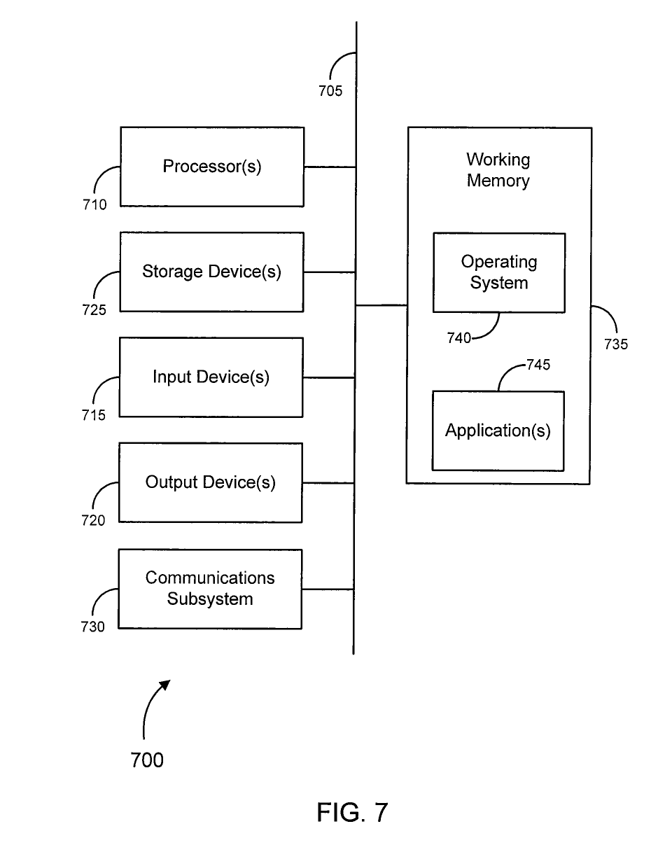

FIG. 7 provides a schematic illustration of one embodiment of a computer system 700 that can perform the methods of the invention, as described herein, and/or can function as, for example, processing center 405 (FIG. 4), universal card platform 410 (FIG. 4), etc. It should be noted that FIG. 7 is meant only to provide a generalized illustration of various components, any or all of which may be utilized as appropriate. FIG. 7, therefore, broadly illustrates how individual system elements may be implemented in a relatively separated or relatively more integrated manner.

The computer system 700 is shown comprising hardware elements that can be electrically coupled via a bus 705 (or may otherwise be in communication, as appropriate). The hardware elements can include one or more processors 710, including, without limitation, one or more general-purpose processors and/or one or more special-purpose processors (such as digital signal processing chips, graphics acceleration chips, and/or the like); one or more input devices 715, which can include, without limitation, a mouse, a numeric keypad, a keyboard, a touch screen, and/or the like; and one or more output devices 720, which can include, without limitation, a display device, a printer, a soundcard and/or the like.

The computer system 700 may further include (and/or be in communication with) one or more storage devices 725, which can comprise, without limitation, local and/or network accessible storage and/or can include, without limitation, a disk drive, a drive array, an optical storage device, a solid-state storage device, such as a random access memory (“RAM”) and/or a read-only memory (“ROM”), which can be programmable, flash-updateable and/or the like. The computer system 700 might also include a communications subsystem 730, which can include without limitation a modem, a network card (wireless or wired), an infra-red communication device, a wireless communication device and/or chipset (such as a Bluetooth™ device, an 802.11 device, a WiFi device, a WiMax device, cellular communication facilities, etc.), and/or the like. The communications subsystem 730 may permit data to be exchanged with a network (such as the network described below, to name one example), and/or any other devices described herein. In many embodiments, the computer system 700 will further comprise a working memory 735, which can include a RAM or ROM device, as described above.

The computer system 700 can also comprise software elements, shown as being currently located within the working memory 735, including an operating system 740 and/or other code, such as one or more application programs 745, which may comprise computer programs of the invention, and/or may be designed to implement methods of the invention and/or configure systems of the invention, as described herein. Merely by way of example, one or more procedures described with respect to the method(s) discussed above might be implemented as code and/or instructions executable by a computer (and/or a processor within a computer). A set of these instructions and/or code might be stored on a computer readable storage medium, such as the storage device(s) 725 described above. In some cases, the storage medium might be incorporated within a computer system, such as the system 700. In other embodiments, the storage medium might be separate from a computer system (e.g., a removable medium, such as a compact disc, etc.), and or provided in an installation package, such that the storage medium can be used to program a general purpose computer with the instructions/code stored thereon. These instructions might take the form of executable code, which is executable by the computer system 700 and/or might take the form of source and/or installable code, which, upon compilation and/or installation on the computer system 700 (e.g., using any of a variety of generally available compilers, installation programs, compression/decompression utilities, etc.) then takes the form of executable code.

It will be apparent to those skilled in the art that substantial variations may be made in accordance with specific requirements. For example, customized hardware might also be used, and/or particular elements might be implemented in hardware, software (including portable software, such as applets, etc.), or both. Further, connection with other computing devices such as network input/output devices may be employed.

In one aspect, the invention employs a computer system (such as the computer system 700) to perform methods of the invention. According to a set of embodiments, some or all of the procedures of such methods are performed by the computer system 700 in response to processor 710 executing one or more sequences of one or more instructions (which might be incorporated into the operating system 740 and/or other code, such as an application program 745) contained in the working memory 735. Such instructions may be read into the working memory 735 from another machine-readable medium, such as one or more of the storage device(s) 725. Merely by way of example, execution of the sequences of instructions contained in the working memory 735 might cause the processor(s) 710 to perform one or more procedures of the methods described herein.

The terms “machine-readable medium” and “computer readable medium”, as used herein, refer to any medium that participates in providing data that causes a machine to operate in a specific fashion. In an embodiment implemented using the computer system 700, various machine-readable media might be involved in providing instructions/code to processor(s) 710 for execution and/or might be used to store and/or carry such instructions/code (e.g., as signals). In many implementations, a computer readable medium is a physical and/or tangible storage medium. Such a medium may take many forms, including but not limited to, non-volatile media, volatile media, and transmission media. Non-volatile media includes, for example, optical or magnetic disks, such as the storage device(s) 725. Volatile media includes, without limitation, dynamic memory, such as the working memory 735. Transmission media includes coaxial cables, copper wire and fiber optics, including the wires that comprise the bus 705, as well as the various components of the communication subsystem 730 (and/or the media by which the communications subsystem 730 provides communication with other devices). Hence, transmission media can also take the form of waves (including without limitation radio, acoustic and/or light waves, such as those generated during radio-wave and infra-red data communications).

Common forms of physical and/or tangible computer readable media include, for example, a floppy disk, a flexible disk, hard disk, magnetic tape, or any other magnetic medium, a CD-ROM, any other optical medium, punchcards, papertape, any other physical medium with patterns of holes, a RAM, a PROM, an EPROM, a FLASH-EPROM, any other memory chip or cartridge, a carrier wave as described hereinafter, or any other medium from which a computer can read instructions and/or code.

Various forms of machine-readable media may be involved in carrying one or more sequences of one or more instructions to the processor(s) 710 for execution. Merely by way of example, the instructions may initially be carried on a magnetic disk and/or optical disc of a remote computer. A remote computer might load the instructions into its dynamic memory and send the instructions as signals over a transmission medium to be received and/or executed by the computer system 700. These signals, which might be in the form of electromagnetic signals, acoustic signals, optical signals and/or the like, are all examples of carrier waves on which instructions can be encoded, in accordance with various embodiments of the invention.

The communications subsystem 730 (and/or components thereof) generally will receive the signals, and the bus 705 then might carry the signals (and/or the data, instructions, etc., carried by the signals) to the working memory 735, from which the processor(s) 705 retrieves and executes the instructions. The instructions received by the working memory 735 may optionally be stored on a storage device 725 either before or after execution by the processor(s) 710.

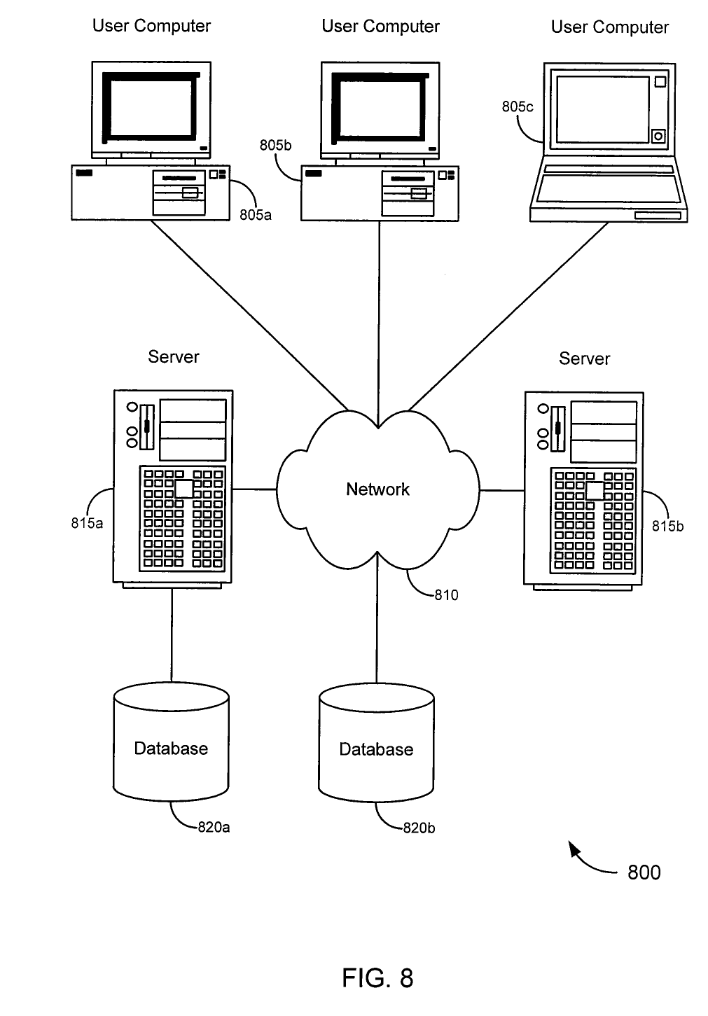

A set of embodiments comprises systems for managing an identity database and generating an identity confidence scoring system. Merely by way of example, FIG. 8 illustrates a schematic diagram of a system 800 that can be used in accordance with one set of embodiments. The system 800 can include one or more user computers 805. The user computers 805 can be general purpose personal computers (including, merely by way of example, personal computers and/or laptop computers running any appropriate flavor of Microsoft Corp.'s Windows™ (e.g., Vista™) and/or Apple Corp.'s Macintosh™ operating systems) and/or workstation computers running any of a variety of commercially-available UNIX™ or UNIX-like operating systems. These user computers 805 can also have any of a variety of applications, including one or more applications configured to perform methods of the invention, as well as one or more office applications, database client and/or server applications, and/or web browser applications. Alternatively, the user computers 805 can be any other electronic device, such as a thin-client computer, Internet-enabled mobile telephone, and/or personal digital assistant (PDA), capable of communicating via a network (e.g., the network 810 described below) and/or displaying and/or navigating web pages or other types of electronic documents. Although the exemplary system 800 is shown with three user computers 805, any number of user computers can be supported.

Certain embodiments of the invention operate in a networked environment, which can include a network 810. The network 810 can be any type of network familiar to those skilled in the art that can support data communications using any of a variety of commercially-available protocols, including without limitation TCP/IP, SNA, IPX, AppleTalk, and the like. Merely by way of example, the network 810 can be a local area network (“LAN”), including without limitation an Ethernet network, a Token-Ring network and/or the like; a wide-area network (WAN); a virtual network, including without limitation a virtual private network (“VPN”); the Internet; an intranet; an extranet; a public switched telephone network (“PSTN”); an infra-red network; a wireless network, including without limitation a network operating under any of the IEEE 802.11 suite of protocols, the Bluetooth™ protocol known in the art, and/or any other wireless protocol; and/or any combination of these and/or other networks.

Embodiments of the invention can include one or more server computers 815. Each of the server computers 815 may be configured with an operating system, including without limitation any of those discussed above, as well as any commercially (or freely) available server operating systems. Each of the servers 815 may also be running one or more applications, which can be configured to provide services to one or more clients 805 and/or other servers 815.

Merely by way of example, one of the servers 815 may be a web server, which can be used, merely by way of example, to process requests for web pages or other electronic documents from user computers 805. The web server can also run a variety of server applications, including HTTP servers, FTP servers, CGI servers, database servers, Java™ servers, and the like. In some embodiments of the invention, the web server may be configured to serve web pages that can be operated within a web browser on one or more of the user computers 805 to perform methods of the invention.

The server computers 815, in some embodiments, might include one or more application servers, which can include one or more applications accessible by a client running on one or more of the client computers 805 and/or other servers 815. Merely by way of example, the server(s) 815 can be one or more general purpose computers capable of executing programs or scripts in response to the user computers 805 and/or other servers 815, including without limitation web applications (which might, in some cases, be configured to perform methods of the invention). Merely by way of example, a web application can be implemented as one or more scripts or programs written in any suitable programming language, such as Java™, C, C#™ or C++, and/or any scripting language, such as Perl, Python, or TCL, as well as combinations of any programming/scripting languages. The application server(s) can also include database servers, including without limitation those commercially available from Oracle™, Microsoft™, Sybase™, IBM™ and the like, which can process requests from clients (including, depending on the configuration, database clients, API clients, web browsers, etc.) running on a user computer 805 and/or another server 815. In some embodiments, an application server can create web pages dynamically for displaying the information in accordance with embodiments of the invention, such as web interface 419 (FIG. 4). Data provided by an application server may be formatted as web pages (comprising HTML, Javascript, etc., for example) and/or may be forwarded to a user computer 805 via a web server (as described above, for example). Similarly, a web server might receive web page requests and/or input data from a user computer 805 and/or forward the web page requests and/or input data to an application server. In some cases, a web server may be integrated with an application server.

In accordance with further embodiments, one or more servers 815 can function as a file server and/or can include one or more of the files (e.g., application code, data files, etc.) necessary to implement methods of the invention incorporated by an application running on a user computer 805 and/or another server 815. Alternatively, as those skilled in the art will appreciate, a file server can include all necessary files, allowing such an application to be invoked remotely by a user computer 805 and/or server 815. It should be noted that the functions described with respect to various servers herein (e.g., application server, database server, web server, file server, etc.) can be performed by a single server and/or a plurality of specialized servers, depending on implementation-specific needs and parameters.

In certain embodiments, the system can include one or more databases 820. The location of the database(s) 820 is discretionary: merely by way of example, a database 820a might reside on a storage medium local to (and/or resident in) a server 815a (and/or a user computer 805). Alternatively, a database 820b can be remote from any or all of the computers 805, 815, so long as the database can be in communication (e.g., via the network 810) with one or more of these. In a particular set of embodiments, a database 820 can reside in a storage-area network (“SAN”) familiar to those skilled in the art. (Likewise, any necessary files for performing the functions attributed to the computers 805, 815 can be stored locally on the respective computer and/or remotely, as appropriate.) In one set of embodiments, the database 820 can be a relational database, such as an Oracle™ database, that is adapted to store, update, and retrieve data in response to SQL-formatted commands. The database might be controlled and/or maintained by a database server, as described above, for example.

In a further embodiment, a transaction system which includes a loyalty host to administer the loyalty programs may be provided. In some instances, the loyalty host may be a component of the one or more machines included in the transaction system performing other functions. Alternatively, the loyalty host may be a standalone system receiving transaction details from another component of the transaction system. The loyalty host may be used to automatically enroll customers in a loyalty program.

In one embodiment, a merchant may offer services to perform money transfer transactions. The customer may initiate a money transfer transaction by walking into a merchant location and providing details of the money transfer transaction to an agent. Money transfer transaction details may include recipient information, money transfer amount, and/or information about the customer (sender), such as a telephone number. The agent may enter the details into a POS device. When all the details have been entered, the POS device may transmit the transaction information to a transaction host for processing. Alternatively, the customer may initiate a money transfer transaction at a kiosk or other user input device.

While the invention has been described with respect to exemplary embodiments, one skilled in the art will recognize that numerous modifications are possible. For example, the methods and processes described herein may be implemented using hardware components, software components, and/or any combination thereof. Further, while various methods and processes described herein may be described with respect to particular structural and/or functional components for ease of description, methods of the invention are not limited to any particular structural and/or functional architecture but instead can be implemented on any suitable hardware, firmware and/or software configuration. Similarly, while various functionality is ascribed to certain system components, unless the context dictates otherwise, this functionality can be distributed among various other system components in accordance with different embodiments of the invention.

Moreover, while the procedures comprised in the methods and processes described herein are described in a particular order for ease of description, unless the context dictates otherwise, various procedures may be reordered, added, and/or omitted in accordance with various embodiments of the invention. Moreover, the procedures described with respect to one method or process may be incorporated within other described methods or processes; likewise, system components described according to a particular structural architecture and/or with respect to one system may be organized in alternative structural architectures and/or incorporated within other described systems. Hence, while various embodiments are described with—or without—certain features for ease of description and to illustrate exemplary features, the various components and/or features described herein with respect to a particular embodiment can be substituted, added and/or subtracted from among other described embodiments, unless the context dictates otherwise. Consequently, although the invention has been described with respect to exemplary embodiments, it will be appreciated that the invention is intended to cover all modifications and equivalents within the scope of the following claims.

What is claimed is:

1. A method of providing universal access to loyalty programs and financial accounts, the method comprising:
initializing a universal loyalty program account and financial account device;
associating at least one loyalty program account with the universal loyalty program and financial instrument device;
associating at least one financial account with the universal loyalty program and financial instrument device; and
accessing at least one of the at least one loyalty program account or the at least one financial account at a customer facing device using the universal loyalty program account and financial account device.

2. The method of claim 1, further comprising:
adding an additional loyalty program account or financial account to the universal loyalty program account and financial account device; and
removing one of the at least one loyalty program account or one of the at least one financial account from the universal loyalty program account and financial account device.

3. The method of claim 2, wherein the adding and removing of the loyalty program accounts further comprise providing access to an account management interface which displays each of the loyalty program accounts and each of the financial accounts associated with the universal loyalty program account and financial account device.

4. The method of claim 1, wherein the universal loyalty program account and financial account device comprises one or more of the following: an electronic key fob, a cellular device, a presentation instrument with a magnetic stripe, a presentation instrument with a bar code, and a presentation instrument with a radio frequency (RF) chip.

5. The method of claim 1, wherein the at least one loyalty program account comprises one or more of the following account types: a retail store, a shoe store, a book store, a grocery store, a department store, a video rental store, a library, an airline, and a hotel.

6. The method of claim 1, wherein the at least one financial account comprises one or more of the following account types: a credit card account, a debit account, a money transfer account, a stored value account, and an electronic wallet account.

7. The method of claim 1, wherein the at least one loyalty program account and the at least one financial account comprises reward points which are accumulated based on usage of the accounts and according to rules of each account.

8. The method of claim 7, further comprising sharing and combining the reward points from multiple loyalty program and financial accounts.

9. The method of claim 7, further comprising:
exchanging reward points from one or more of the at least one loyalty program account or financial account for a cash amount;
distributing the cash amount via a money transfer; and
retrieving the money transfer at a money transfer agent location.

10. The method of claim 7, further comprising:
transferring the rewards points to another customer's loyalty program account(s) or financial account(s); and
transferring the rewards points to a charitable organization.

11. The method of claim 10, wherein the exchanging and transferring operations comprise an associated fee, wherein the fee is a net fee.

12. A universal loyalty program account and financial account device, the device comprising:
a storage mechanism configured to store account information for at least one loyalty program account and a at least one financial account associated with the universal loyalty program account and financial account device;
a display screen coupled with the storage mechanism, the display screen configured to display account information for one or more of the at least one loyalty program account or the at least one financial account; and
a button mechanism coupled with the storage mechanism and the display screen, the button mechanism configured to manipulate the account information displayed on the display screen.

13. The device of claim 12, wherein the display screen is a touch screen, wherein the touch screen is configured to allow for the manipulation of the account information displayed on the display screen.

14. The device of claim 12, wherein the account information displayed on the display screen comprises a barcode associated with one of the at least one loyalty program.

15. The device of claim 14, wherein the button mechanism is further configured to cycle through barcodes associated with the at least one loyalty program account each instance that the button mechanism is pressed.

16. The device of claim 12, further comprising a biometric mechanism coupled with the storage mechanism, the biometric device configured to restrict access to the universal loyalty program account and financial account device based on valid biometric data received at the biometric mechanism.

17. A system for providing universal access to loyalty programs, the system comprising:
a processing center configured to initialize a universal loyalty program account device and associate at least one loyalty program account with the universal loyalty program device; and
a customer facing device coupled with the processing center, the customer facing device configured to access at least one of the at least one loyalty program account using the universal loyalty program account device.

18. The system of claim 17, further comprising at least one vendor network associated with the at least one loyalty program account, wherein the at least one vendor network are configured to transmit messages regarding one or more of coupons, rebates, sweepstakes, special offers, and combination offers to an account holder of the universal loyalty program account device.

19. The system of claim 18, wherein the messages are transmitted using one or more of the following transmission types: an email, a short message system (SMS) message, a text message, a voicemail, and an instant messenger message.

20. The system of claim 17, wherein the customer facing device comprises one or more of the following: an automated teller machine (ATM), a point-of-sale (POS) device, a kiosk, and an in-lane device.

21. A machine-readable medium having a set of instructions stored thereon for providing universal access to loyalty programs and financial accounts which, when executed by a machine, cause the machine to:
initialize a universal loyalty program account and financial account device;
associate at least one loyalty program account with the universal loyalty program and financial instrument device;
associating at least one financial account with the universal loyalty program and financial instrument device; and
accessing at least one of the at least one loyalty program account or the at least one financial account at a customer facing device using the universal loyalty program account and financial account device.
